(19) United States
(12) Patent Application Publication
(10) Pub. No.: US 2015/0189108 A1
(43) Pub. Date: Jul. 2, 2015

(54) TRANSMISSION CIRCUIT AND CAMERA SYSTEM

(71) Applicant: Kabushiki Kaisha Toshiba, Tokyo (JP)

(72) Inventor: Shinichi Mizuguchi, Kawasaki (JP)

(73) Assignee: KABUSHIKI KAISHA TOSHIBA, Tokyo (JP)

(21) Appl. No.: 14/481,354

(22) Filed: Sep. 9, 2014

(30) Foreign Application Priority Data
Dec. 26, 2013 (JP) 2013-269799

(51) Int. Cl. H04N 1/00; H04N 19/68; H04N 19/66

(52) U.S. Cl. CPC H04N 1/00204; H04N 19/66; H04N 19/68; H04N 2201/0084; H04N 2201/0068; H04N 2201/0025

(57) ABSTRACT

A transmission circuit according to an embodiment comprises an input section, a frame information generation section, a frame packet generation section and a data packet generation section. To the input section, information for designating a plurality of virtual channel numbers, for transmission of the data by assigning the data in each set to different channels, is inputted in a case of frame signals having the same period. The frame information generation section generates frame information based on a frame signal. The frame packet generation section sequentially outputs a plurality of frame packets which are generated by respectively adding the information of the virtual channel numbers to the frame information at timing based on the frame signal. The data packet generation section generates data packets by combining the plurality of data and the virtual channel numbers and outputs the generated data packets.

### CROSS-REFERENCE TO RELATED APPLICATION

This application is based upon and claims the benefit of priority from the Japanese Patent Application No. 2013-269799, filed on Dec. 26, 2013; the entire contents of which are incorporated herein by reference.

### FIELD

Embodiments described herein relate generally to transmission circuits and camera systems.

### BACKGROUND

Generally, a transmission circuit for transmitting an image data is configured to use frame signals, line signals and data signals as input signals and transmit a transmission data generated from the input signals in frame units. In a case of transmitting a plurality of image data by one physical transmission means using such a transmission circuit, virtual channels are used for distinguishing the data.

For example, in a case of transmitting a plurality of image data in a plurality of virtual channels using such a transmission circuit, the virtual channels are switched in the frame units. However, since the transmission data is transmitted in a time-division manner in the frame units, the image data for one frame in a specified virtual channel cannot be transmitted until it becomes the time at which the transmission is possible. Therefore, there are problems that a frame memory for temporally storing the image data for one frame is necessitated in a module or the like at a supply source of the image data, and that the transmitting timing is delayed by one frame or more.

It is noted that it is necessary to implement transmission circuits for the number of virtual channels in order to transmit each image data within one frame using a plurality of virtual channels. However, in a case of the configuration in which the transmission circuits for the number of virtual channels are implemented, there is a problem that a circuit scale is increased in accordance with the number of virtual channels.

### BRIEF DESCRIPTION OF THE DRAWINGS

FIG. 1 is a diagram showing a configuration of a camera system provided with a transmission circuit according to a first embodiment;

FIG. 2 is a diagram showing a detailed configuration of a format conversion section 13 in the first embodiment;

FIG. 3 is a timing chart adopted when transmitting image data from a camera module 2;

FIG. 4 is a diagram showing a configuration of a display system provided with a transmission circuit according to a modified example of the first embodiment;

FIG. 5 is a timing chart adopted when transmitting image data to a display module;

FIG. 6 is another timing chart adopted when transmitting image data to the display module;

FIG. 7 is another timing chart adopted when transmitting image data from the camera module 2;

FIG. 8 is a diagram showing a detailed configuration of a format conversion section 13a in a second embodiment;

FIG. 9 is a diagram showing a detailed configuration of a format conversion section 13b in a third embodiment;

FIG. 10 is a diagram showing a detailed configuration of a format conversion section 13c in a fourth embodiment; and

FIG. 11 is a diagram showing a detailed configuration of a format conversion section 13d in a fifth embodiment.

### DETAILED DESCRIPTION

A transmission circuit according to an embodiment comprises an input section, a frame information generation section, a frame packet generation section and a data packet generation section. To the input section, a plurality of sets of a frame signal and data are inputted and information for designating a plurality of virtual channel numbers, for transmission of the data by assigning the data in each set to different channels, is inputted in a case of the frame signals having the same period. The frame information generation section generates frame information based on the frame signal inputted to the input section. The frame packet generation section sequentially outputs a plurality of frame packets which are generated by respectively adding information of the virtual channel numbers to the frame information at timing based on the frame signal inputted to the input section. The data packet generation section generates data packets by combining the plurality of data inputted to the input section and the virtual channel numbers designated for the plurality of data and outputs the generated data packets.

Hereinafter, embodiments of the present invention will be described in detail referring to the drawings.

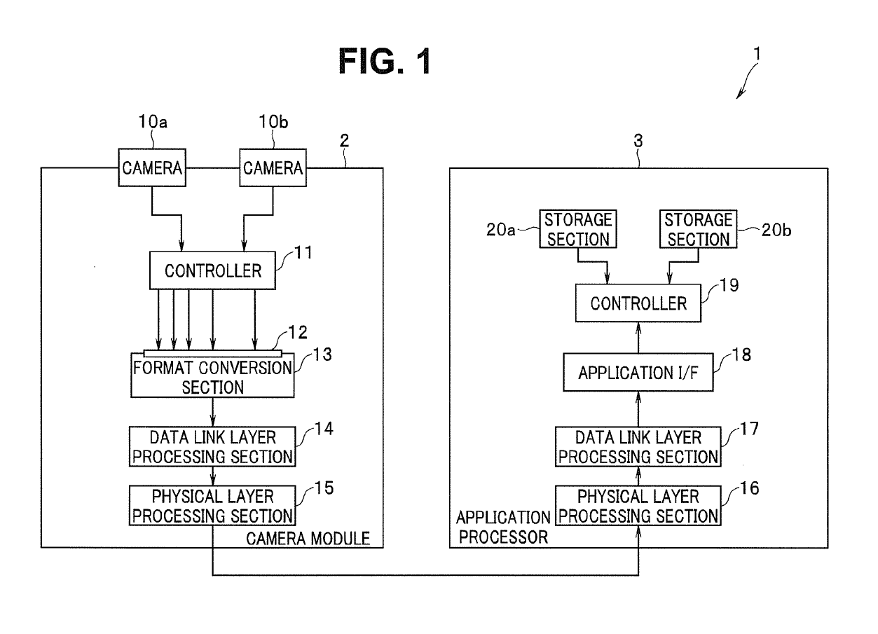

First, a configuration of a camera system provided with a transmission circuit according to a first embodiment will be described. FIG. 1 is a diagram showing the configuration of the camera system provided with the transmission circuit according to the first embodiment.

A camera system 1 of the present embodiment is a camera system to be used in a mobile phone, a smart phone, or the like for example and is configured to include a camera module 2 and an application processor 3. The camera system 1 of the present embodiment transmits image data of an image captured by cameras 10a and 10b of the camera module 2 to the application processor 3 by serial data using a plurality of virtual channels in one frame.

The camera module 2 is configured to include the two cameras 10a and 10b, a controller 11, a hardware interface (hereinafter referred to as “hardware I/F”) 12, a format conversion section 13, a data link layer processing section 14 and a physical layer processing section 15. The transmission circuit of the present embodiment is constituted by the hardware I/F 12 and the format conversion section 13.

Further, the application processor 3 is configured to include a physical layer processing section 16, a data link layer processing section 17, an application interface (hereinafter referred to as “application I/F”) 18, a controller 19 and storage sections 20a and 20b. Besides, the camera module 2 is configured to include the two cameras 10a and 10b, but the number of cameras is not limited to two.

The two cameras 10a and 10b output the image data of the captured image to the controller 11.

The controller 11, upon input of the image data, outputs a data signal, a line signal, a designation signal of virtual channel numbers for line (hereinafter referred to as “line VC number designation signals”), a frame signal, a designation signal of virtual channel numbers for frame (hereinafter referred to as “frame VC number designation signals”) to the hardware I/F 12.

The hardware I/F 12 is an interface for signal input from the controller 11 to the format conversion section 13.

The format conversion section 13 generates packet data obtained by packetizing the signals from the hardware I/F 12 and outputs the generated packet data to the data link layer processing section 14.

The data link layer processing section 14 performs processing of a data link layer for adding a header and an error correction, etc. to the packet data from the format conversion section 13, to generate packet data with the header, the error correction, etc. added, and outputs the generated packet data to the physical layer processing section 15.

The physical layer processing section 15 performs processing of a physical layer for electrically converting the packet data generated by the data link layer processing section 14 into LVDS signals, for example, and transmits the converted packet data to the application processor 3 by serial data.

The physical layer processing section 16 of the application processor 3 performs processing of a physical layer for converting the transmitted LVDS signals as the serial data into original packet data, for example, and outputs the converted packet data to the data link layer processing section 17.

The data link layer processing section 17 performs processing of a data link layer for performing error correction or the like, of the packet data from the physical layer processing section 16, and outputs the packet data subjected to the error correction to the application I/F 18.

The application I/F 18 generates the image data outputted by the cameras 10a and 10b from the packet data from the data link layer processing section 17, and outputs the image data to the controller 19.

The controller 19 performs control for storing the image data from the application I/F 18 in the storage section 20a or 20b.

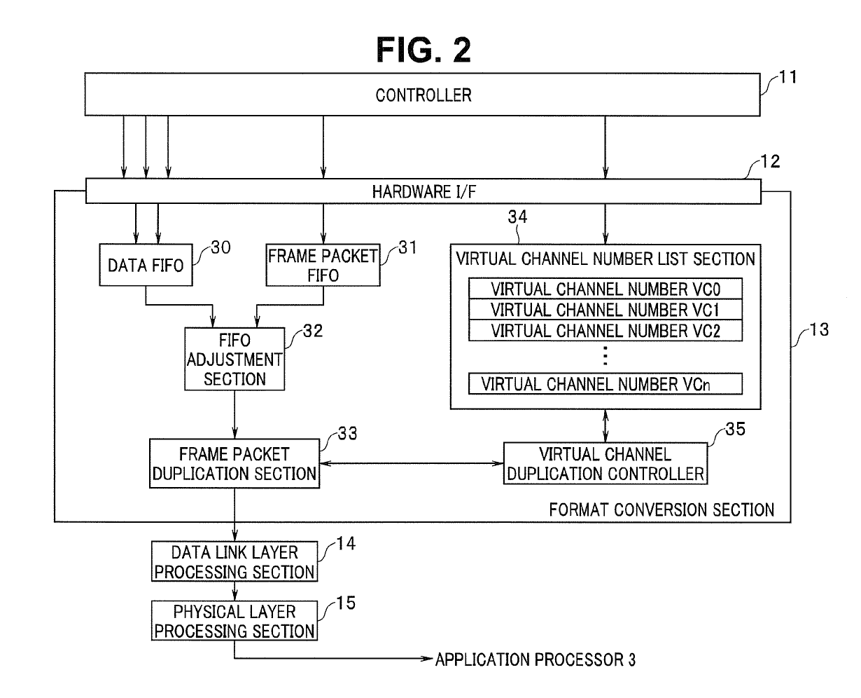

FIG. 2 is a diagram showing a detailed configuration of the format conversion section 13 in the first embodiment.

The format conversion section 13 is configured to include a data FIFO 30, a frame packet FIFO 31, a FIFO adjustment section 32, a frame packet duplication section 33, a virtual channel number list section 34 and a virtual channel duplication controller 35. The frame VC number designation signals are inputted to the virtual channel number list section 34 through the hardware I/F 12 and is registered as a duplication virtual channel number list.

In the present embodiment, the controller 11 designates two virtual channels for the cameras 10a and 10b. In the present embodiment, the controller 11 assigns virtual channel numbers for different virtual channels to the cameras 10a and 10b so as to enable data transmission in two virtual channels in one frame period. For example, when transmitting the image data from the camera 10a, the controller 11 transmits the image data by assigning a virtual channel of a virtual channel number VC0, and when transmitting the image data from the camera 10b, the controller 11 transmits the image data by assigning a virtual channel of a virtual channel number VC1.

The data signal, the line signal, the line VC number designation signals, the frame signal, and the frame VC number designation signals are inputted to the hardware I/F 12 as an input section.

The hardware I/F 12, as a frame information generation section, generates information (frame start information) showing a frame start by a rising edge of the frame signal and generates the virtual channel number for designating the virtual channel assigned to the camera 10a, and generates a frame start packet FS containing the frame start information and the virtual channel number. Besides, the hardware I/F 12 may be configured to generate the frame start information by a falling edge of the frame signal, for example, without being limited to the rising edge of the frame signal, and generate the virtual channel number for designating the virtual channel assigned to the camera 10a, and generate the frame start packet FS containing the frame start information and the virtual channel number.

In the similar manner, the hardware I/F 12 generates information (frame end information) showing a frame end by a falling edge of the frame signal and generates the virtual channel number for designating the virtual channel assigned to the camera 10a, and generates a frame end packet FE containing the frame end information and the virtual channel number. Besides, the hardware I/F 12 may be configured to generate the frame end information by a rising edge of the frame signal, for example, without being limited to the falling edge of the frame signal, and generate the virtual channel number for designating the virtual channel assigned to the camera 10a, and generate the frame end packet FE containing the frame end information and the virtual channel number. More specifically, the hardware I/F 12 generates the frame end packet FE by a next edge of the edge of the frame signal by which the frame start information is generated.

The hardware I/F 12 outputs the generated frame start packet FS and frame end packet FE to the frame packet FIFO 31. The frame packet FIFO 31 outputs the frame start packet FS and the frame end packet FE inputted from the hardware I/F 12 to the FIFO adjustment section 32 after temporally holding these inputted packets.

Further, the hardware I/F 12 generates the virtual channel number for designating the virtual channel by a rising edge of the line signal based on the line VC number designation signals and generates a line start packet LS containing the virtual channel number. Besides, the hardware I/F 12 may be configured to generate the virtual channel number for designating the virtual channel by a falling edge of the line signal, for example, without being limited to the rising edge of the line signal, and generate the line start packet LS containing the virtual channel number. Further, the virtual channel number for the line data can be transmitted by being incorporated into a packet header of the line data. Therefore, the application processor 3 on a receiving side can recognize the virtual channel number by the packet for the line data without transmission of the virtual channel number for the line data by the line start packet LS. Thus, the hardware I/F 12 may be configured not to generate the line start packet LS. In the following description, the generation and transmission of the line start packet LS is not essential, and the generation and transmission of the line start packet LS may not be performed.

Further, the hardware I/F 12, as a data packet generation section, generates the data packet associated with the virtual channel number, from the data signal which is inputted subsequently to the line signal and also the designated virtual channel number.

The hardware I/F 12 outputs the generated data packet to the data FIFO 30. The data FIFO 30 outputs the data packet inputted from the hardware I/F 12 to the FIFO adjustment section 32 after temporally holding the data packet.

The FIFO adjustment section 32 performs adjustment of outputs of the frame start packet FS, the frame end packet FE and the data packet, and outputs these packets to the frame packet duplication section 33.

Further, the frame VC number designation signals are inputted to the virtual channel number list section 34 through the hardware I/F 12 and registered as a duplication virtual channel number list. The virtual channel duplication controller 35 generates a frame start duplication packet FSD and a frame end duplication packet FED, as described later, using the duplication virtual channel number list registered in the virtual channel number list section 34. Besides, it may be configured that the frame VC number designation signals are inputted to the virtual channel duplication controller 35 through the hardware I/F 12 and the virtual channel duplication controller 35 reads the virtual channel number designated by the frame VC number designation signals from the virtual channel number list section 34 in which the virtual channel numbers are stored in advance.

Specifically, the virtual channel duplication controller 35, when the frame start packet FS is inputted to the frame packet duplication section 33, reads the virtual channel number contained in the frame start packet FS.

In a case where a virtual channel number which is different from the virtual channel number contained in the frame start packet FS is registered in the virtual channel number list section 34, the virtual channel duplication controller 35 controls the frame packet duplication section 33 to generate a frame start duplication packet FSD containing the different virtual channel number.

At this time, the virtual channel duplication controller 35 controls the frame packet duplication section 33 to generate a frame start duplication packet FSD which contains every virtual channel number of the virtual channel numbers registered in the virtual channel number list section 34 except the virtual channel number contained in the frame start packet FS. That is, the number of duplicated frame start duplication packets FSD is not limited to one, and in dependence on the number of virtual channel numbers designated by the frame VC number designation signals, a plurality of frame start duplication packets FSD are generated by duplication.

When the frame packet duplication section 33 is instructed to generate a frame start duplication packet FSD by the virtual channel duplication controller 35, the frame packet duplication section 33 duplicates the frame start information in the frame start packet FS and generates the frame start duplication packet FSD in which the virtual channel number given from the virtual channel duplication controller 35 is added to the duplicated frame start information.

In the same manner, when the frame end packet FE is inputted to the frame packet duplication section 33, the virtual channel duplication controller 35 reads the virtual number contained in the frame end packet FE.

In a case where a virtual channel number which is different from the virtual channel number included in the frame end packet FE is registered in the virtual channel number list section 34, the virtual channel duplication controller 35 controls the frame packet duplication section 33 to generate a frame end duplication packet FED containing the different virtual channel number.

At this time, the virtual channel duplication controller 35 controls the frame packet duplication section 33 to generate a frame end duplication packet FED which contains every virtual channel number of the virtual channel numbers registered in the virtual channel number list section 34 except the virtual channel number contained in the frame end packet FE. That is, the number of frame end duplication packets FED to be duplicated is not limited to one, and in dependence on the number of virtual channel numbers designated by the frame VC number designation signals, a plurality of frame end duplication packets FED are generated by duplication.

The frame start duplication packet FSD and the frame end duplication packet FED are generated so as to indicate by what virtual channel number for the virtual channel the data are to be transmitted in one frame. By generating these frame start duplication packet FSD and frame end duplication packet FED and setting the virtual channel numbers of the plurality of virtual channels used in the transmission at the start and end of one frame, it is configured that the data of the cameras 10a and 10b are received without causing any trouble in the application processor 3 on the receiving side and the respective data are restored.

When the frame packet duplication section 33 is instructed to generate the frame end duplication packet FED by the virtual channel duplication controller 35, the frame packet duplication section 33 duplicates the frame end information in the frame end packet FE and generates the frame end duplication packet FED in which the virtual channel number given from the virtual channel duplication controller 35 is added to the duplicated frame end information.

The frame packet duplication section 33 sequentially outputs the generated one or more frame start duplication packets FSD subsequently to the frame start packet FS. Further, the frame packet duplication section 33 sequentially outputs the generated one or more frame end duplication packets FED subsequently to the frame end packet FE. Then, the frame packet duplication section 33 outputs the other data from the FIFO adjustment section 32 between the frame start duplication packet FSD which is outputted last and the frame end packet FE. Besides, the output timing of the other data is not limited to the above, and for example, the frame packet duplication section 33 may output the other data from the FIFO adjustment section 32 after the output of the frame start duplication packet FSD which is outputted last and before the next frame start packet FS.

### (Operation)

Next, an operation of the camera system thus configured will be described.

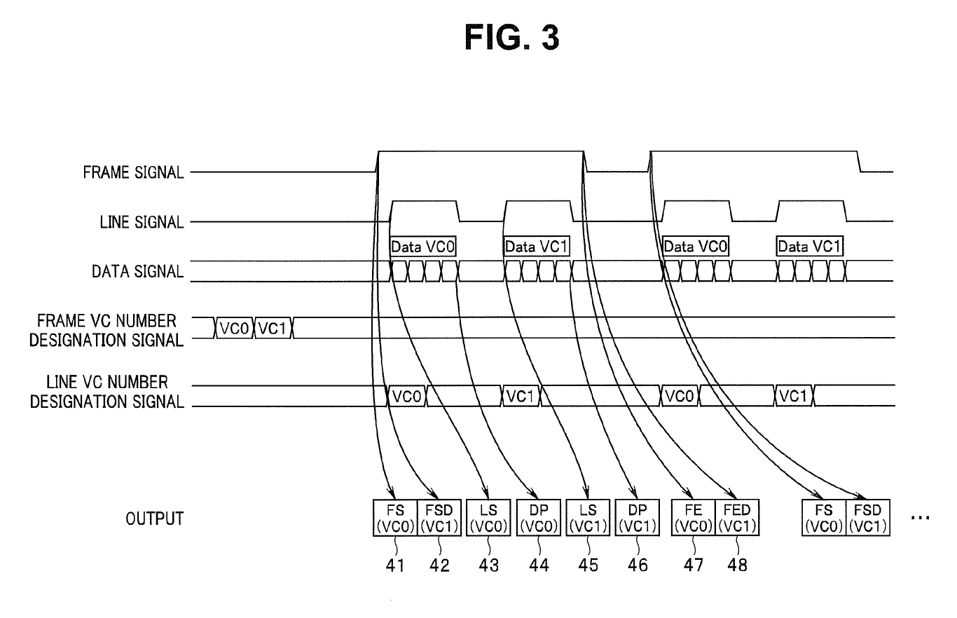

FIG. 3 is a timing chart adopted when transmitting the image data from the camera module 2.

The cameras 10a and 10b capture an image simultaneously and the camera 10a transmits a frame signal, a line signal, a data signal to the controller 11 and also the camera 10b transmits a frame signal, a line signal, a data signal to the controller 11.

The following description will be made assuming that the controller 11, when transmitting the image data from the camera 10a, transmits the image data by assigning the virtual channel of the virtual channel number VC0, and when transmitting the image data from the camera 10b, transmits the image data by assigning the virtual channel of the virtual channel number VC1. Besides, the configuration of the transmission by assigning the virtual channel of the virtual channel number VC0 to the image data from the camera 10a and by assigning the virtual channel of the virtual channel number VC1 to the image data from the camera 10b is one example and other configuration may be adopted. For example, it may be configured such that the camera module 2 is configured to include only the camera 10a and the transmission is performed by assigning the virtual channel of the virtual channel number VC0 to the image data from the camera 10a and assigning the virtual channel of the virtual channel number VC1 to a control data from the camera 10a. The controller 11 outputs the signals shown in FIG. 3, namely, the frame signal in common from the cameras 10a and 10b, the respective line signals on the basis of the cameras 10a and 10b, the respective data signals, the frame VC number designation signals and the line VC number designation signals, the latter two signals being in accordance with the assigned virtual channel numbers.

Besides, it is assumed that periods of the frame signals of the data obtained by the cameras 10a and 10b are the same. Further, the number of virtual channel numbers is two in FIG. 3 but it is not limited to two and may be three or more.

The hardware I/F 12, upon input of the frame signal from the controller 11, generates the frame start information at the rising edge of the frame signal and generates a frame start packet FS 41 with the information of the virtual channel number VC0, which is assigned to the camera 10a, being added, and outputs the generated packet to the frame packet FIFO 31. The FIFO adjustment section 32 reads the frame start packet FS 41 in the frame packet FIFO 31 and outputs the read packet to the frame packet duplication section 33.

On the other hand, the frame VC number designation signals are inputted to the virtual channel number list section 34 through the hardware I/F 12 and registered as the duplication virtual channel number list. The virtual channel duplication controller 35 reads a virtual channel number of other virtual channel used in the same frame from the virtual channel number list section 34 by referring to the duplication virtual channel number list of the virtual channel number list section 34 and the virtual channel number of the frame start packet FS 41 inputted to the frame packet duplication section 33, and sets the read number to the frame packet duplication section 33.

Here, the virtual channel number added to the frame start packet FS 41 is VC0 and the virtual channel numbers designated by the frame VC number designation signals are VC0 and VC1. Therefore, the virtual channel number of the other virtual channel used in the same frame is VC1.

The frame packet duplication section 33 duplicates the frame start information of the frame start packet FS 41 and generates a frame start duplication packet FSD 42 with the virtual channel number VC1 added. If another virtual channel number is designated by the frame VC number designation signals, the frame packet duplication section 33 repeats similar processing. The frame packet duplication section 33 sequentially outputs the frame start packet FS 41 and the frame start duplication packet FSD 42 to the data link layer processing section 14. The frame start packet FS 41 and the frame start duplication packet FSD 42 are subjected to the processing of the data link layer by the data link layer processing section 14, and then subjected to the processing of the physical layer by the physical layer processing section 15, and outputs shown in FIG. 3 are outputted to the application processor 3.

Thus, as shown in FIG. 3, the frame start packet FS 41 and the frame start duplication packet FSD 42 are outputted at the rising edge of the frame signal.

Next, the line signal for transmitting the data from the camera 10a is supplied to the hardware I/F 12. Besides, the hardware I/F 12 may generate a line start packet LS 43 containing the virtual channel number VC0 assigned in the line VC number designation signals at a rising edge of the line signal, and output the generated signal to the data FIFO 30. As mentioned above, this processing is not essential.

Further, after rising of the line signal for transmitting the data from camera 10a, the data of the camera 10a is inputted to the hardware I/F 12. The hardware I/F 12 generates a data packet DP 44 from the data and outputs the generated packet to the data FIFO 30.

The FIFO adjustment section 32 sequentially reads the line start packet LS 43 and the data packet DP 44 which contain the virtual channel number VC0 from the data FIFO 30, and outputs the read packets to the data layer processing section 14 through the frame packet duplication section 33. The line start packet LS 43 and the data packet DP 44 are subjected to the processing of the data link layer by the data link layer processing section 14 and then subjected to the processing of the physical layer by the physical processing layer section 15, and outputs shown in FIG. 3 are outputted to the application processor 3.

Next, in the present embodiment, the line signal for transmitting the data from the camera 10b is supplied to the hardware I/F 12. Besides, the hardware I/F 12 may generate a line start packet LS 45 containing the virtual channel number VC1 assigned in the line VC number designation signals by a rising edge of the line signal, and output the generated signal to the data FIFO 30. As mentioned above, this processing is not essential.

Further, upon rising of the line signal for transmitting the data from camera 10b, the data of the camera 10b is inputted to the hardware I/F 12. The hardware I/F 12 generates a data packet DP 46 from the data and outputs the generated packet to the data FIFO 30. The FIFO adjustment section 32 sequentially reads the line start packet LS 45 and the data packet DP 46 which contain the virtual channel number VC1 from the data FIFO 30 and outputs the read packets to the data layer processing section 14 through the frame packet duplication section 33. The line start packet LS 45 and the data packet DP 46 are subjected to the processing of the data link layer by the data link layer processing section 14 and then subjected to the processing of the physical layer by the physical processing layer section 15, and outputs shown in FIG. 3 are outputted to the application processor 3. Subsequently, the same processing is repeated for the number of lines in one frame period.

Next, the hardware I/F 12, when it becomes time of the falling edge of the frame signal, generates the frame end information at the falling edge of the frame signal and generates a frame end packet FE 47 with information of the virtual channel number VC0, which is assigned to the camera 10a, being added, and outputs the generated packet to the frame packet FIFO 31. The FIFO adjustment section 32 reads the frame end packet FS 47 in the frame packet FIFO 31 and outputs the read packet to the frame packet duplication section 33.

On the other hand, the frame VC number designation signals are inputted to the virtual channel number list section 34 through the hardware I/F 12 and registered as the duplication virtual channel number list. The virtual channel duplication controller 35 reads a virtual channel number of other virtual channel used in the same frame from the virtual channel number list section 34 by referring to the duplication virtual channel number list of the virtual channel number list section 34 and the virtual channel number of the frame end packet FE 47 inputted to the frame packet duplication section 33, and sets the read number in the frame packet duplication section 33.

Here, the virtual channel number added to the frame end packet FE 47 is VC0 and the virtual channel numbers designated by the frame VC number designation signals are VC0 and VC1. Therefore, the virtual channel number of the other virtual channel used in the same frame is VC1.

The frame packet duplication section 33 duplicates the frame end information of the frame end packet FE 47 and generates a frame end duplication packet FED 48 with the virtual channel number VC1 added. If another virtual channel number is designated by the frame VC number designation signals, the frame packet duplication section 33 repeats similar processing. The frame packet duplication section 33 sequentially outputs the frame end packet FE 47 and the frame end duplication packet FED 48 to the data link layer processing section 14. The frame end packet FE 47 and the frame end duplication packet FED 48 are subjected to the processing of the data link layer by the data link layer processing section 14, and then subjected to the processing of the physical layer by the physical layer processing section 15, and outputs shown in FIG. 3 is outputted to the application processor 3.

Thus, as shown in FIG. 3, the frame end packet FS 47 and the frame end duplication packet FED 48 are outputted at the falling edge of the frame signal. Subsequently, the same processing is repeated for all of the frames.

As described above, the hardware I/F 12 and the format conversion section 13 which constitute the transmission circuit of the present embodiment enable outputting of the data of the camera 10a and 10b during outputting of one frame by giving the plurality of virtual channels to one frame and adding the virtual channel numbers for the virtual channels. Since the virtual channel numbers for the plurality of virtual channels used in the transmission are set at the start and end of one frame, it is possible that the data from the cameras 10a and 10b are received without causing any trouble in the application processor 3 on the receiving side and the respective data are restored.

Thereby, in the camera module 2, a frame memory for temporarily storing the image data of one frame is made unnecessary and the transmission timing is not delayed. Further, since the camera module 2 transmits the image data within one frame using the plurality of virtual channels, it is not necessary to implement transmission circuits for the numbers of virtual channels and the circuit scale does not increase.

Thus, according to the transmission circuit of the present embodiment, it is possible to transmit data within one frame using the plurality of virtual channels without increasing the circuit scale.

Besides, it is configured that the virtual channel number added to the frame start packet FS 41 and the frame end packet FE 47 is prepared in the hardware I/F 12, but it may be configured that, in the hardware I/F 12, the frame start packet FS 41 containing only the frame start information and the frame end packet FE 47 containing only the frame end information are generated and outputted.

In this case, the frame packet duplication section 33 generates the frame start packet FS 41 with the virtual channel number of VC0 added, and duplicates the packet to generate the frame start duplication packet FSD 42 with the virtual channel number of VC1 added, based on control of the virtual channel duplication controller 35. In the same manner, the frame packet duplication section 33 generates the frame end packet FE 47 with the virtual channel number of VC0 added, and duplicates the packet to generate the frame end duplication packet FED 48 with the virtual channel number of VC1 added based on control of the virtual channel duplication controller 35.

As described, the frame packet duplication section 33 and the virtual channel duplication controller 35 constitute a frame packet generation section that sequentially outputs a plurality of frame packets each generated by adding the information of the virtual channel number to the frame information.

### Modified Example 1

Next, modified example 1 of the first embodiment will be described.

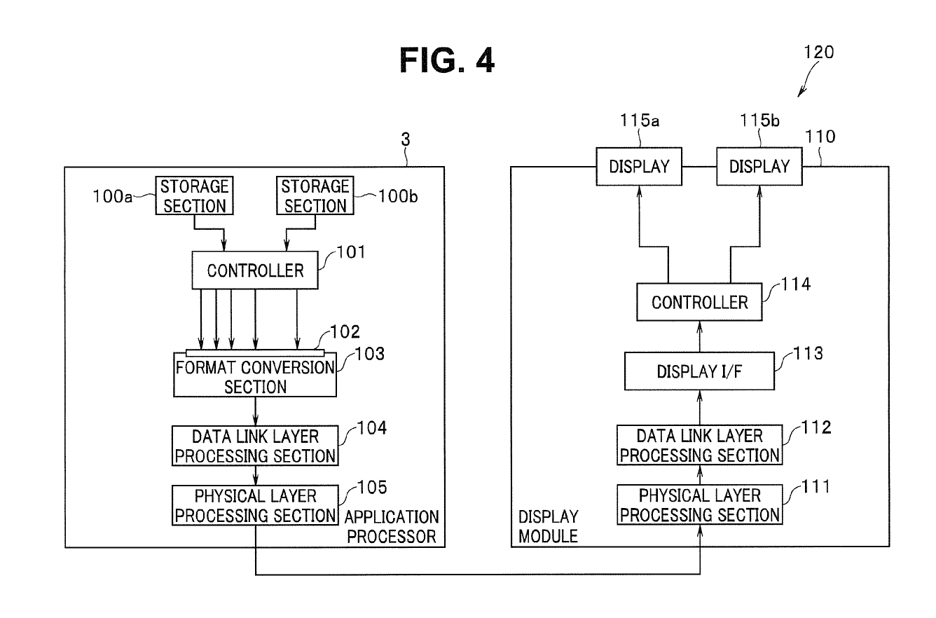

In the modified example 1, an example of transmitting the image data from an application processor 3 to a display module will be described. FIG. 4 is a diagram showing a configuration of a display system provided with a transmission circuit according to the modified example of the first embodiment.

As shown in FIG. 4, a display system 120 of the modified example 1 transmits image data stored in storage sections 100a and 100b of the application processor 3 to a display module 110 by serial data using a plurality of virtual channels in one frame.

The application processor 3 is configured to include the two storage sections 100a and 100b, a controller 101, a hardware I/F 102, a format conversion section 103, a data link layer processing section 104 and a physical layer processing section 105.

Further, the display module 110 is configured to include a physical layer processing section 111, a data link layer processing section 112, a display I/F 113, a controller 114, and two displays 115a and 115b.

In the modified example 1, the controller 101 designates two virtual channels for the storage sections 100a and 100b. In the modified example 1, since the controller 101 assigns virtual channel numbers for different virtual channels to the storage sections 100a and 100b so as to enable data transmission in two virtual channels in one frame period. For example, when transmitting the image data stored in the storage section 100a, the controller 101 transmits the image data by assigning a virtual channel of a virtual channel number VC0, and when the controller 101 transmits the image data stored in the storage section 100b, the controller 101 transmits the image data by assigning a virtual channel of a virtual channel number VC1.

It is noted that the controller 101, the hardware I/F 102, the format conversion section 103, the data link processing section 104 and the physical layer processing section 105 of the application processor 3 have the same configurations as the controller 11, the hardware I/F 12, the format conversion section 13, the data link processing section 14 and the physical layer processing section 15, respectively, and therefore the description thereof is omitted. Further, the physical layer processing section 111, the data link layer processing section 112 of the display module 110 have the same configurations as the physical layer processing section 16 and the data link layer processing section 17, respectively, and therefore the description thereof is omitted.

Further, the detailed configuration of the format conversion section 103 is the same as shown in FIG. 2, and the following description will be made using FIG. 2 with the respective configurations and reference signs, assuming that FIG. 2 shows the same configuration as that of the format conversion section 103.

The display I/F 113 of the display module 110 generates the image data that are stored in the storage sections 100a and 100b from the packet data from the data ling layer processing section 112 and outputs the generated data to the controller 114.

The controller 114 performs control of displaying the image data from the display I/F 113 on the display 115a or 115b in accordance with the assigned virtual channel number.

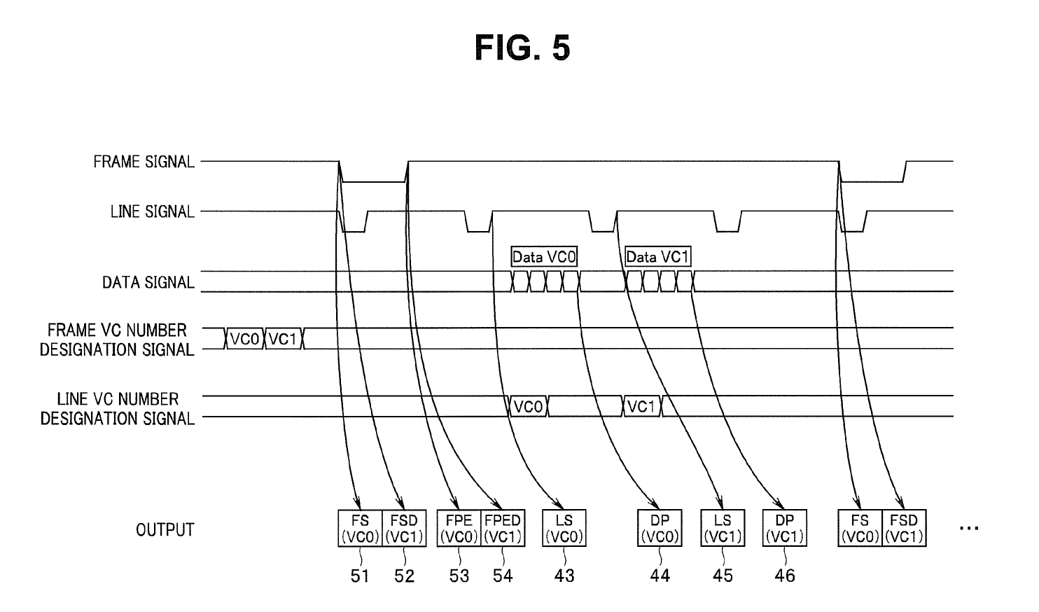

FIG. 5 is a timing chart adopted when transmitting the image data to the display module. It is noted that, with respect to the same configurations as those in FIG. 3, the same reference signs are assigned in FIG. 5 and the description thereof is omitted. In the timing chart shown in FIG. 5, one frame is defined from a falling edge of one frame signal to a falling edge of the next frame signal and the data transmission is performed after the frame start packet is transmitted.

In the modified example 1, data transmission using a plurality of virtual channels within one frame is enabled by generating information indicative of a delimiter of a frame by a falling edge of the frame signal and generating a plurality of packets containing virtual channel numbers of virtual channels used in one frame.

The hardware I/F 102, upon input of the frame signal from the controller 101, generates the frame start information by the falling edge of the frame signal and generates a frame start packet FS 51 with the information of the virtual channel number VC0, which is assigned to the storage section 100a, being added, and outputs the generated packet to the frame packet FIFO 31.

The FIFO adjustment section 32 reads the frame start packet FS 51 in the frame packet FIFO 31 and outputs the read packet to the frame packet duplication section 33.

On the other hand, the frame VC number designation signals are inputted to the virtual channel number list section 34 through the hardware I/F 12 and registered as the duplication virtual channel number list. The virtual channel duplication controller 35 reads a virtual channel number of other virtual channel used in the same frame from the virtual channel number list section 34 by referring to the duplication virtual channel number list of the virtual channel number list section 34 and the virtual channel number of the frame start packet FS 51 inputted to the frame packet duplication section 33.

Here, the virtual channel number added to the frame start packet FS 51 is VC0 and the virtual channel numbers designated by the frame VC number designation signals are VC0 and VC1. Therefore, the virtual channel number of the other virtual channel used in the same frame is VC1.

The frame packet duplication section 33 duplicates the frame start information of the frame start packet FS 51 and generates a frame start duplication packet FSD 52 with the virtual channel number VC1 added. If another virtual channel number is designated by the frame VC number designation signals, the frame packet duplication section 33 repeats similar processing. The frame packet duplication section 33 sequentially outputs the frame start packet FS 51 and the frame start duplication packet FSD 52 to the data link layer processing section 104. The frame start packet FS 51 and the frame start duplication packet FSD 52 are subjected to the processing of the data link layer by the data link layer processing section 104, and then subjected to the processing of the physical layer by the physical layer processing section 105, and outputs shown in FIG. 5 are outputted to the display module 110.

Thus, as shown in FIG. 5, the frame start packet FS 51 and the frame start duplication packet FSD 52 are outputted at the falling edge of the frame signal.

Next, the hardware I/F 12 generates the frame pulse width end information by the rising edge of the frame signal and generates a frame pulse width end packet FPE 53 with information of the virtual channel number VC0, which is assigned to the storage section 100a, being added, and outputs the generated packet to the frame packet FIFO 31. The FIFO adjustment section 32 reads the frame pulse width end packet FPE 53 in the frame packet FIFO 31 and outputs the read packet to the frame packet duplication section 33.

On the other hand, the frame VC number designation signals are inputted to the virtual channel number list section 34 through the hardware I/F 102 and registered as the duplication virtual channel number list. The virtual channel duplication controller 35 reads a virtual channel number of other virtual channel used in the same frame from the virtual channel number list section 34 by referring to the duplication virtual channel number list of the virtual channel number list section 34 and the virtual channel number of the frame pulse width end packet FPE 53 inputted to the frame packet duplication section 33, and sets the read number in the frame packet duplication section 33.

Here, the virtual channel number added to the frame pulse width end packet FPE 53 is VC0 and the virtual channel numbers designated by the frame VC number designation signals are VC0 and VC1. Therefore, the virtual channel number of the other virtual channel used in the same frame is VC1.

The frame packet duplication section 33 duplicates the frame pulse end information of the frame pulse width end packet FPE 53 and generates a frame pulse width end duplication packet FPED 54 with the virtual channel number VC1 added.

The frame start duplication packet FSD and the frame pulse width end duplication packet FPED are generated so as to indicate by what virtual channel number for the virtual channel the data are to be transmitted in one frame. By generating these frame start duplication packet FSD and frame pulse width end duplication packet FPED and setting the virtual channel numbers of the plurality of virtual channels used in the transmission at the start and end of one frame, it is configured that the data of the storage sections 100a and 100b are received without causing any trouble in the display module 110 on the receiving side and the respective data are restored.

If another virtual channel number is designated by the frame VC number designation signals, the frame packet duplication section 33 repeats similar processing.

The frame packet duplication section 33 sequentially outputs the frame pulse width end packet FPE 53 and the frame pulse width end duplication packet FPED 54 to the data link layer processing section 104. The frame pulse width end packet FPE 53 and the frame pulse width end duplication packet FPED 54 are subjected to the processing of the data link layer by the data link layer processing section 104, and then subjected to the processing of the physical layer by the physical layer processing section 105, and outputs shown in FIG. 5 are outputted to the display module 110.

Thus, as shown in FIG. 5, the frame pulse width end packet FPE 53 and the frame pulse width end duplication packet FPED 54 are outputted at the rising edge of the frame signal.

Thereafter, the line start packet LS 43 containing the virtual channel number VC0, the data packet DP 44, the line start packet LS 45 containing the virtual channel number VC1 and the data packet 46 are outputted in the same manner as FIG. 3.

Since the frame start packet FS 51, the frame start duplication packet FSD 52, the frame pulse width end packet FPE 53 and the frame pulse width end duplication packet FPED 54 to which the virtual channel numbers to be used within one frame are respectively added, it is possible to recognize and restore the data at the display module 110 on the receiving side. In this case, the same effect as that of FIG. 3 can be obtained.

The timing chart adopted when transmitting the image data to the display module 110 is not limited to FIG. 5.

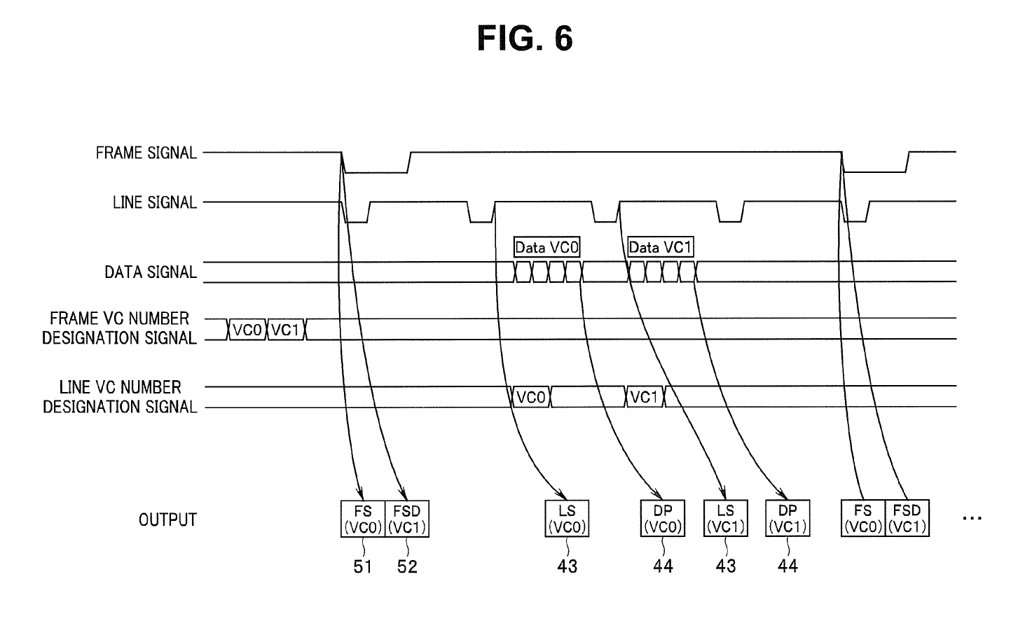

FIG. 6 is another timing chart adopted when transmitting the image data to the display module. It is noted that, with respect to the same configurations as those in FIG. 5, the same reference signs are assigned in FIG. 6 and the description thereof is omitted.

In the display module 110 on the receiving side, the frame pulse width end packet FPE 53 and the frame pulse width end duplication packet FPED 54 are not necessarily needed for recognizing the data to be restored in the respective virtual channels.

In the timing chart shown in FIG. 6, it is configured that the hardware I/F 102 does not generate the frame pulse width end packet FPE 53 shown in FIG. 5 at the rising edge of the frame signal. Therefore, the frame packet duplication section 33 does not generate the frame pulse width end duplication packet FPED 54, shown in FIG. 5, with the virtual channel number VC1 added. In this case also, the same effect as that of FIG. 5 can be obtained.

### Modified Example 2

Next, a modified example 2 of the first embodiment will be described.

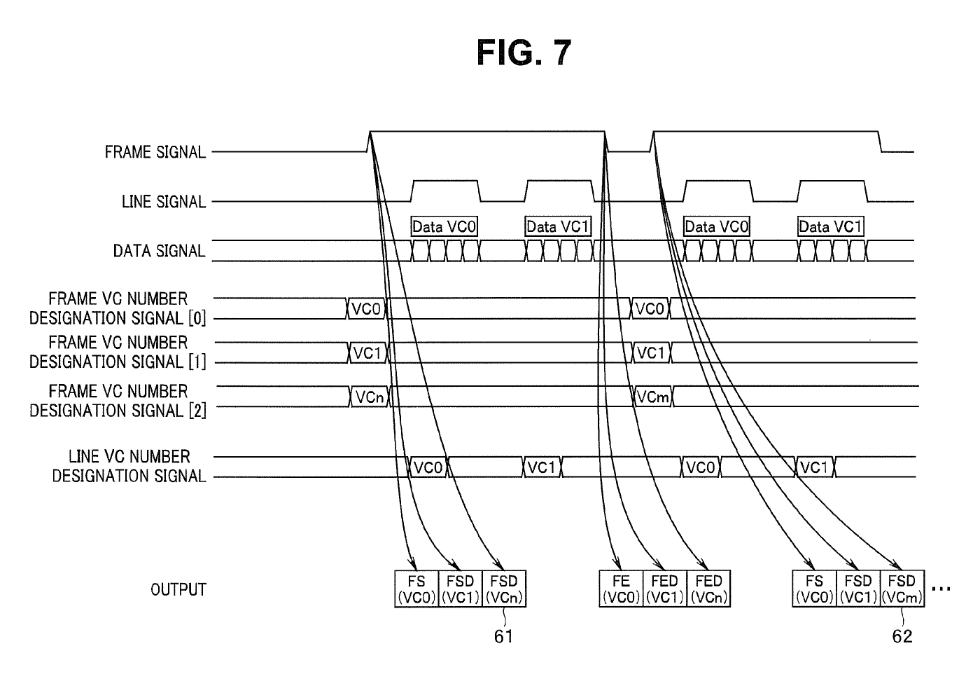

FIG. 7 is another timing chart adopted when transmitting image data from the camera module 2.

The timing chart of FIG. 7 is an example in which a plurality of frame VC number designation signals, e.g. three frame VC number designation signals [0], [1] and [2] are used. It is noted that the number of frame VC number designation signals is not limited to three and may be, for example, two, three, four or more. Further, it is configured that the frame VC number designation signals [0], [1] and [2] can respectively designate the virtual channel numbers at each rising edge of the frame signal.

At a rising edge of a first frame signal, a frame start duplication packet FSD 61 containing a virtual channel number VCn in accordance with the frame VC number designation signals [2] is duplicated by the frame packet duplication section 33. By contrast, at a rising edge of a second frame signal, a frame start duplication packet FSD 62 containing a virtual channel number VCm in accordance with the frame VC number designation signals [2] is duplicated by the frame packet duplication section 33.

As described above, by designating the virtual channel number for each rising edge of the frame signal, it becomes possible to change the virtual channel number to be duplicated for each frame signal.

### Second Embodiment

Next, the second embodiment will be described.

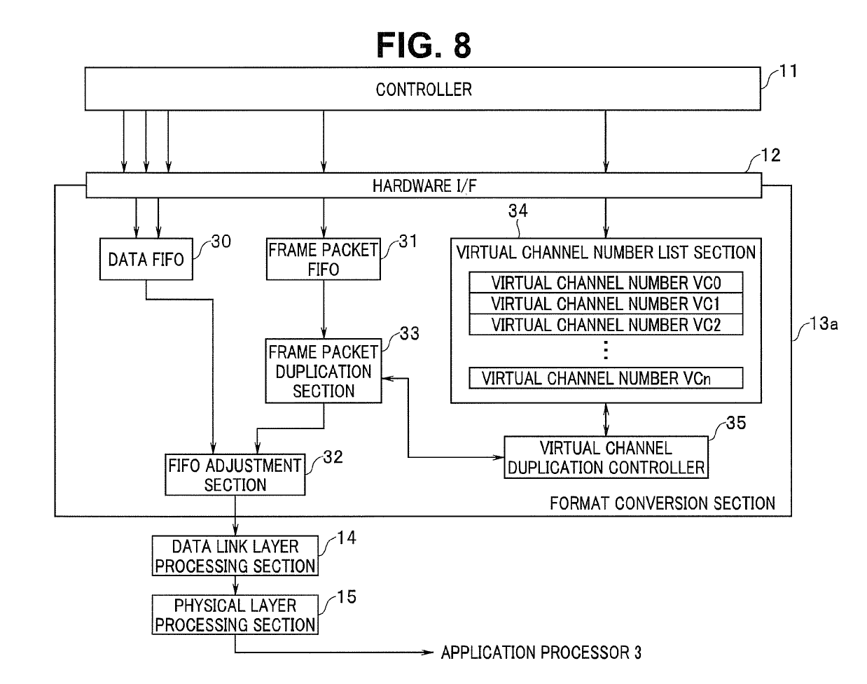

FIG. 8 is a diagram showing a detailed configuration of a format conversion section 13a in the second embodiment. It is noted that, with respect to the same configurations as those in FIG. 2, the same reference signs are assigned in FIG. 8 and the description thereof is omitted.

The format conversion section 13a of the second embodiment differs from the format conversion section 13 in arrangement of the frame packet duplication section 33. In the format conversion section 13 of FIG. 2, the frame packet duplication section 33 is arranged in a subsequent stage of the FIFO adjustment section 32 and in a previous stage of the data link processing section 14. In contrast, the in the format conversion section 13a of the present embodiment, the frame packet duplication section 33 is arranged in a subsequent stage of the frame packet FIFO 31 and in a previous stage of the FIFO adjustment section 32.

The frame packet duplication section 33, upon input of the frame start packet FS containing the frame start information and the virtual channel number from the frame packet FIFO 31, outputs the frame start packet FS to the FIFO adjustment section 32. Further, subsequently to this output, the frame packet duplication section 33 duplicates the frame start information of the frame start packet FS based on control of the virtual channel duplication controller 35. Then, the frame packet duplication section 33 generates the frame start duplication packet FSD in which the virtual channel number, which is given from the virtual channel duplication controller 35, is added to the duplicated frame start information, and outputs the generated packet to the FIFO adjustment section 32.

In the same manner, the frame packet duplication section 33, upon input of the frame end packet FE containing the frame end information and the virtual channel number from the frame packet FIFO 31, outputs the frame end packet FE to the FIFO adjustment section 32. Further, subsequently to this output, the frame packet duplication section 33 duplicates the frame end information of the frame end packet FE based on control of the virtual channel duplication controller 35. Then, the frame packet duplication section 33 generates the frame end duplication packet FED in which the virtual channel number, which is given from the virtual channel duplication controller 35, is added to the duplicated frame end information, and outputs the generated packet to the FIFO adjustment section 32.

With the above configuration, the format conversion section 13a can obtain the same outputs as those in FIG. 3, and it is possible to obtain the same effect as that of the first embodiment.

### Third Embodiment

Next, the third embodiment will be described.

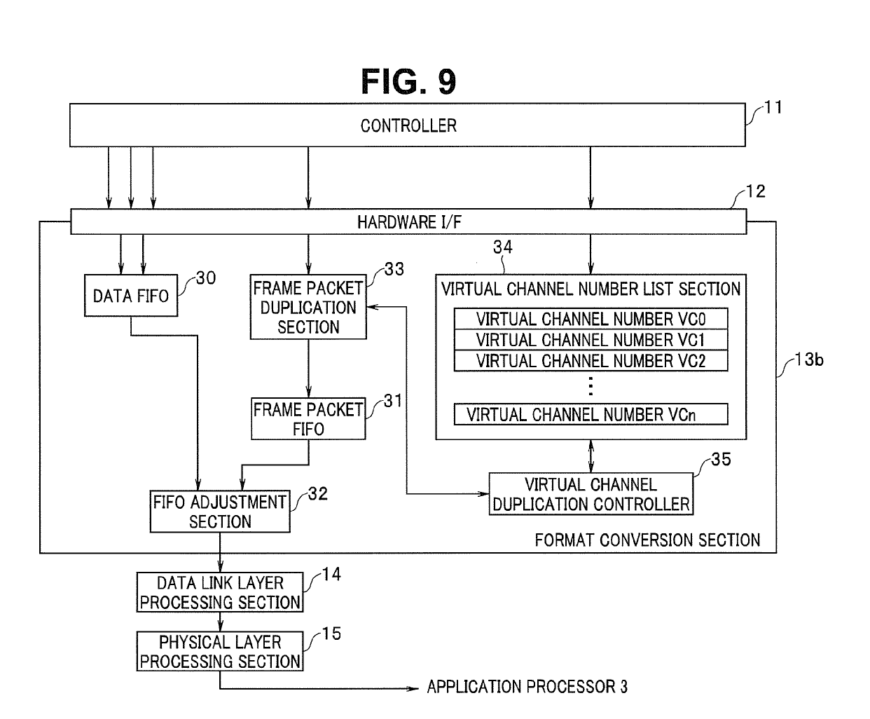

FIG. 9 is a diagram showing a detailed configuration of a format conversion section 13b in the third embodiment. It is noted that, with respect to the same configurations as those in FIG. 8, the same reference signs are assigned in FIG. 9 and the description thereof is omitted.

The format conversion section 13b of the third embodiment differs from the format conversion section 13a in FIG. 8 in arrangement of the frame packet duplication section 33. In the format conversion section 13a of FIG. 8, the frame packet duplication section 33 is arranged in a subsequent stage of the frame packet FIFO 31 and in a previous stage of the FIFO adjustment section 32. In contrast, in the format conversion section 13b, the frame packet duplication section 33 is arranged in a subsequent stage of the hardware I/F 12 and in a previous stage of the frame packet FIFO 31.

The frame packet duplication section 33, upon input of the frame start packet FS containing the frame start information and the virtual channel number from the hardware I/F 12, outputs the frame start packet FS to the frame packet FIFO 31. Further, subsequently to this output, the frame packet duplication section 33 duplicates the frame start information of the frame start packet FS based on control of the virtual channel duplication controller 35. Then, the frame packet duplication section 33 generates the frame start duplication packet FSD in which the virtual channel number, which is given from the virtual channel duplication controller 35, is added to the duplicated frame start information, and outputs the generated packet to the frame packet FIFO 31.

In the same manner, the frame packet duplication section 33, upon input of the frame end packet FE containing the frame end information and the virtual channel number from the hardware I/F 12, outputs the frame end packet FE to the frame packet FIFO 31. Further, subsequently to this output, the frame packet duplication section 33 duplicates the frame end information of the frame end packet FE based on control of the virtual channel duplication controller 35. Then, the frame packet duplication section 33 generates the frame end duplication packet FED in which the virtual channel number, which is given from the virtual channel duplication controller 35, is added to the duplicated frame end information, and outputs the generated packet to the frame packet FIFO 31.

With the above configuration, the format conversion section 13b can obtain the same outputs as those in FIG. 3, and it is possible to obtain the same effect as that of the first embodiment.

### Fourth Embodiment

Next, the fourth embodiment will be described.

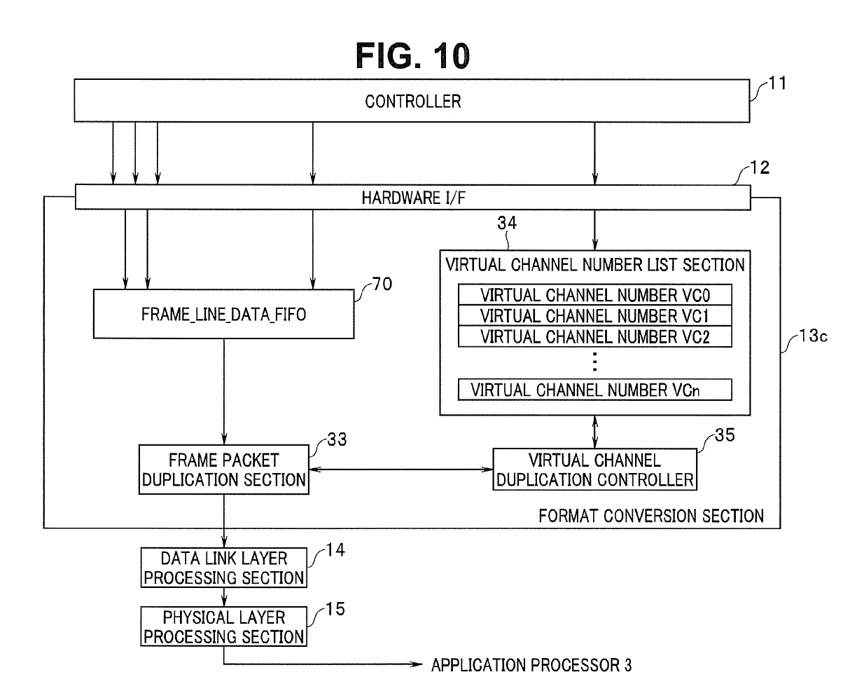

FIG. 10 is a diagram showing a detailed configuration of a format conversion section 13c in the fourth embodiment. It is noted that, with respect to the same configurations as those in FIG. 2, the same reference signs are assigned in FIG. 10 and the description thereof is omitted.

The format conversion section 13c of the present embodiment is configured by deleting the data FIFO 30, the frame packet FIFO 31 and FIFO adjustment section 32 in the format conversion section 13, and adding a frame_line_data FIFO 70.

In FIG. 10, an order of output of the data from the data I/F 12 is determined and the frame start packet FS, the line start packet LS, the data packet DP and the frame end packet FE are outputted in this order from the hardware I/F 12 to the frame_line_data FIFO 70. It is noted that, with respect to the line start packet LS and the data packet DP, a plurality of these packets are outputted according to the number of lines in one frame.

The frame_line_data FIFO 70 outputs the data from the hardware I/F 12 to the frame packet duplication section 33 in the order of input.

The frame packet duplication section 33, upon input of the frame start packet FS, duplicates the frame start information of the frame start packet FS, and generates the frame start duplication packet FSD in which the virtual channel number, which is given from the virtual channel duplication controller 35, is added to the duplicated frame start information, and sequentially outputs the frame start packet FS and the frame start duplication packet FSD to the data link processing section 14.

In the same manner, the frame packet duplication section 33, upon input of the frame end packet FE, duplicates the frame end information of the frame end packet FE, and generates the frame end duplication packet FED in which the virtual channel number, which is given from the virtual channel duplication controller 35, is added to the duplicated frame end information, and sequentially outputs the frame end packet FE and the frame end duplication packet FED to the data link processing section 14.

With the above configuration, the format conversion section 13c can obtain the same outputs as those in FIG. 3, and it is possible to obtain the same effect as that of the first embodiment.

### Fifth Embodiment

Next, the fifth embodiment will be described.

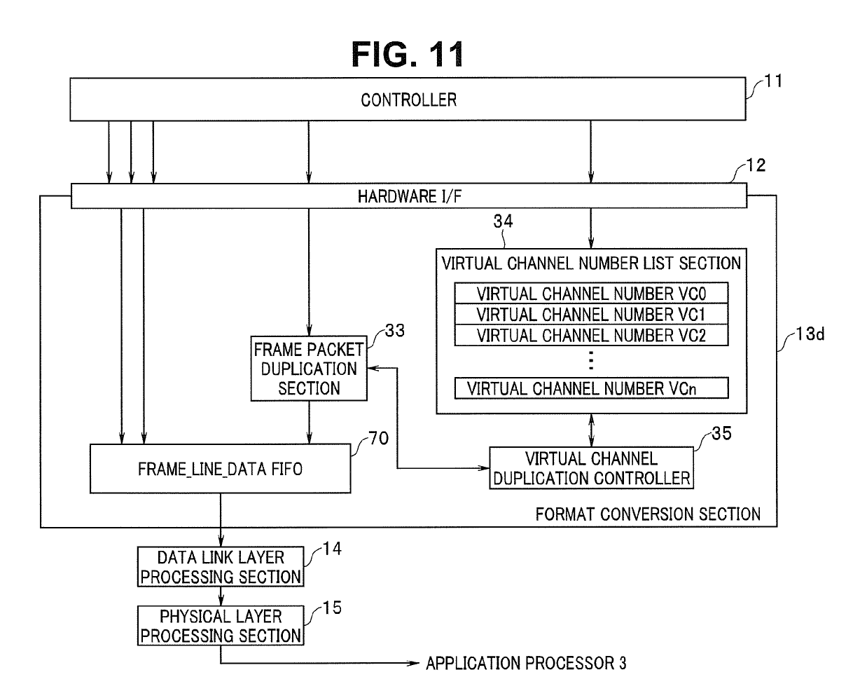

FIG. 11 is a diagram showing a detailed configuration of a format conversion section 13d in the fifth embodiment. It is noted that, with respect to the same configurations as those in FIG. 10, the same reference signs are assigned in FIG. 11 and the description thereof is omitted.

The format conversion section 13d of the fifth embodiment differs from the format conversion section 13c in FIG. 10 in arrangement of the frame packet duplication section 33. In the format conversion section 13c of FIG. 10, the frame packet duplication section 33 is arranged in a subsequent stage of the frame_line_data FIFO 70 and in a previous stage of the data link processing section 14. In contrast, in the format conversion section 13d of the present embodiment, the frame packet duplication section 33 is arranged in a subsequent stage of the hardware I/F 12 and in a previous stage of the frame_line_data FIFO 70.

The frame packet duplication section 33, upon input of the frame start packet FS containing the frame start information and the virtual channel number from the hardware I/F 12, outputs the frame start packet FS to the frame_line_data FIFO 70. Further, subsequently to this output, the frame packet duplication section 33 duplicates the frame start information of the frame start packet FS based on control of the virtual channel duplication controller 35. Then, the frame packet duplication section 33 generates the frame start duplication packet FSD in which the virtual channel number, which is given from the virtual channel duplication controller 35, is added to the duplicated frame start information, and outputs the generated packet to the frame_line_data FIFO 70.

Subsequently to the frame start packet FS and the frame start duplication packet FSD, a plurality of line start packets LS and a plurality of data packets DP are inputted to the frame_line_data FIFO 70.

Next, the frame packet duplication section 33, upon input of the frame end packet FE containing the frame end information and the virtual channel number from the hardware I/F 12, outputs the frame end packet FE to the frame_line_data FIFO 70. Further, subsequently to this output, the frame packet duplication section 33 duplicates the frame end information of the frame end packet FE based on control of the virtual channel duplication controller 35. Then, the frame packet duplication section 33 generates the frame end duplication packet FED in which the virtual channel number, which is given from the virtual channel duplication controller 35, is added to the duplicated frame end information, and outputs the generated packet to the frame_line_data FIFO 70.

The frame_line_data FIFO 70 sequentially outputs the frame start packet FS, the frame start duplication packet FSD, the line start packet LS, the data packet DP, the frame end packet FE and the frame end duplication packet FED to the data link layer processing section 14 in the order of input.

With the above configuration, the format conversion section 13d can obtain the same outputs as those in FIG. 3, and it is possible to obtain the same effect as that of the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmission circuit comprising:
an input section to which a plurality of sets of a frame signal and data are inputted, and to which information for designating a plurality of virtual channel numbers, for transmission of the data by assigning the data in each set to different virtual channels, is inputted in a case of the frame signals having the same period;
a frame information generation section that generates frame information based on the frame signal inputted to the input section;
a frame packet generation section that sequentially outputs a plurality of frame packets which are generated by respectively adding information of the virtual channel numbers to the frame information at timing based on the frame signal inputted to the input section; and
a data packet generation section that generates data packets by combining the plurality of data inputted to the input section and the virtual channel numbers designated for the plurality of data and outputs the generated data packets.

2. The transmission circuit according to claim 1, further comprising a virtual channel number list section that stores information of the plurality of virtual channel numbers,
wherein the frame packet generation section reads the information of the virtual channel numbers designated by the information for designating the virtual channel numbers from the virtual channel number list section and add the read information to the frame information.

3. The transmission circuit according to claim 1, wherein the frame information generation section generates frame start information and frame end information by detecting a rising edge or a falling edge of the frame signal, and
the frame packet generation section sequentially outputs a plurality of frame start packets which are generated by respectively adding the virtual channel numbers to the frame start information, and sequentially outputs a plurality of frame end packets which are generated by respectively adding the virtual channel numbers to the frame end information.

4. The transmission circuit according to claim 1, wherein the frame packet generation section changes the virtual channel numbers of the plurality of virtual channels for each frame signal.

5. The transmission circuit according to claim 2, including a plurality of pieces of information for designating the virtual channel numbers.

6. The transmission circuit according to claim 5, wherein the frame information generation section generates frame start information and frame end information by detecting a rising edge or a falling edge of the frame signal, and
the frame packet generation section changes the virtual channel numbers for each frame start information and sequentially outputs a plurality of frame start packets which are generated by adding the virtual channel numbers based on the plurality of pieces of information for designating the virtual channel numbers, and changes the virtual channel numbers for each frame end information and sequentially outputs a plurality of frame end packets which are generated by adding the virtual channel numbers based on the plurality of pieces of information for designating the virtual channel numbers.

7. The transmission circuit according to claim 6, wherein the frame packet generation section adds the plurality of virtual channel numbers for each rising edge or each falling edge of the frame signal based on the plurality of pieces of information for designating the virtual channel numbers.

8. A camera system comprising:
at least one camera that acquires image data; and
a transmission circuit comprising: an input section to which a plurality of sets of a frame signal and the image data are inputted, and to which information for designating a plurality of virtual channel numbers, for transmission of the image data by assigning the image data in each set to different virtual channels, is inputted in a case of the frame signals having the same period; a frame information generation section that generates frame information based on the frame signal inputted to the input section; a frame packet generation section that sequentially outputs a plurality of frame packets which are generated by respectively adding information of the virtual channel numbers to the frame information at timing based on the frame signal inputted to the input section; and a data packet generation section that generates data packets by combining the plurality of data inputted to the input section and the virtual channel numbers designated for the plurality of data and outputs the generated data packets.

9. The camera system according to claim 8, further comprising a virtual channel number list section that stores information of the plurality of virtual channel numbers,
wherein the frame packet generation section reads the information of the virtual channel numbers designated by the information for designating the virtual channel numbers from the virtual channel number list section and add the read information to the frame information.

10. The camera system according to claim 8, wherein the frame information generation section generates frame start information and frame end information by detecting a rising edge or a falling edge of the frame signal, and
the frame packet generation section sequentially outputs a plurality of frame start packets which are generated by respectively adding the virtual channel numbers to the frame start information, and sequentially outputs a plurality of frame end packets which are generated by respectively adding the virtual channel numbers to the frame end information.

11. The camera system according to claim 8, wherein the frame packet generation section changes the virtual channel numbers of the plurality of virtual channels for each frame signal.

12. The camera system according to claim 9, including a plurality of pieces of information for designating the virtual channel numbers.

13. The camera system according to claim 12, wherein the frame information generation section generates frame start information and frame end information by detecting a rising edge or a falling edge of the frame signal, and
the frame packet generation section changes the virtual channel numbers for each frame start information and sequentially outputs a plurality of frame start packets which are generated by adding the virtual channel numbers based on the plurality of pieces of information for designating the virtual channel numbers, and changes the virtual channel numbers for each frame end information and sequentially outputs a plurality of frame end packets which are generated by adding the virtual channel numbers based on the plurality of pieces of information for designating the virtual channel numbers.

14. The camera system according to claim 13, wherein the frame packet generation section adds the plurality of virtual channel numbers for each rising edge or each falling edge of the frame signal based on the plurality of pieces of information for designating the virtual channel numbers.

15. The camera system according to claim 8, further comprising a data link layer processing section that adds a header and an error correction to the frame packets outputted from the transmission circuit.

16. The camera system according to claim 15, further comprising a physical player processing section that converts the frame packets with the error correction added by the data link layer processing section into a LVDS signal and outputs the converted LVDS signal to an application processor.
